(19) United States
(12) Patent Application Publication
(10) Pub. No.: US 2026/0084524 A1
(43) Pub. Date: Mar. 26, 2026

(54) DISPLAY DEVICE AND CONTROL SYSTEM FOR POTENTIALLY DANGEROUS TECHNICAL SYSTEMS

(71) Applicant: KEBA Industrial Automation GmbH, Linz (AT)

(72) Inventor: Bernhard LEHNER, Hirschbach (AT)

(73) Assignee: KEBA Industrial Automation GmbH, Linz (AT)

(21) Appl. No.: 19/111,386

(22) PCT Filed: Sep. 29, 2023
(86) PCT No.: PCT/AT2023/060341

§ 371 Date: Mar. 13, 2025

(30) Foreign Application Priority Data
Sep. 30, 2022 (DE) 10 2022 125 368.6

(51) Int. Cl. B60K 35/22; B60K 35/10

(52) U.S. Cl. CPC B60K 35/22; B60K 35/10; B60K 2360/1438; B60K 2360/1523

(57) ABSTRACT

A control system for potentially dangerous technical systems and a display device used for the visualization of information are provided. The display device includes a first display with a first display surface and a second display with a second display surface arranged one behind the other. The second display is transparent or at least partially translucent in a direction normal to the second display surface, so that first display contents of the first display can be perceived by the human eye in the normal direction. The first display contents and second display contents of the second display are configured to visualize system or safety relevant information in a cumulative or superimposed manner by superimposing colored representations and/or by mutually supplementing or completing graphical representations. Such a representation or information can be evaluated by a user with regard to plausibility or clearly checked with regard to its correctness.

The invention relates to a display device for the electronically controllable visualization of information, a control system for controlling potentially dangerous technical systems with at least one such display device, and a method for displaying information on an electronically controllable display device, as specified in the claims in each case.

To increase safety, system-critical control systems are known to be redundant. If a sub-component fails, the function that has been lost can usually be completely replaced or taken over by at least one sub-component that is still functional. A severe loss of safety can thus be avoided in many cases.

Furthermore, it is well known that two or more evaluation or computing units can be set up differently and operated in parallel in safety-related control systems. The respective evaluation results or control commands within the control system are then compared. The respective action is only carried out if the results are identical. This can also achieve a safety gain in terms of control technology.

EP 2305534 A1 describes an arrangement and a method for activating a safe operating state for a driverless means of transportation. The driverless means of transportation is controlled by a digital control. The digital control has access to a redundant device for detecting the position of the driverless means of transportation. This redundant position detection of the driverless means of transportation makes it possible to determine at any time whether it is within the defined segment of the route. Such a redundant or fail-safe sensor system for position detection may also be an approach for increasing system safety.

In electronic control systems for potentially dangerous technical systems, it is also very important to display system-relevant information and notifications in a fail-safe manner or as failure-free as possible. Sudden and undetected faults in the control system or in the display device can have serious consequences.

Especially in the case of control systems with partly or fully manual control or operating interventions and/or with a monitoring requirement by an operator, an error-proof or fail-safe display of system-relevant information is of great importance. In this context, the state of the art provides only inadequate solutions.

The object of the present invention was to overcome the disadvantages of the prior art and to provide a device or a method which enables a user to operate technical systems with a enhanced safety against malfunction or failure.

This object is solved by a display device, a control system and a method according to the claims.

The display device according to the invention for the electronically controllable visualization of information, which information can be visually perceived by the human eye of a user, comprises a first display and at least one second display, which first display has a first display surface which is configured or provided for visualizing first display contents. The at least one second display has a second display surface, which is configured or provided for visualizing second display content. The first display surface of the first display and the second display surface of the at least one second display are arranged one after the other or one behind the other in the normal direction to the first and second display surfaces. The first display surface and the second display surface are arranged to overlap one another at least partially, and in particular are positioned to cover or superimpose one another. The at least one second display is transparent or at least partially translucent in the normal direction to its second display surface, so that first display contents on the first display surface of the first display can be perceived by the human eye through the second display surface in the normal direction to the second display surface. First display contents from the first display and second display contents from the at least one second display are provided to visualize system- or safety-relevant information in a cumulative or superimposed manner by superimposing color representations and/or by mutually supplementing or completing graphical representations, in particular to visualize them in a completed or intended manner. Such a representation or information is such that it can be evaluated by a user of the display device with regard to plausibility or can be clearly checked with regard to its correctness.

At least one generic control device and/or a display control device specifically assigned to the first display and to the at least one second display may be configured to assign the respective first and second display contents to the first display and to the at least one second display. In particular, at least one generic control device and/or at least one display control device may be configured for the intended division of the display contents for the first display and the at least one second display.

The specified technical solution therefore provides for at least one transparent or translucent display to be placed over a display, particularly a standard display. Each display can be controlled independently. At least safety-relevant information is displayed split or divided for each display. The complete display content, for example a symbol, and/or the correct color is only visualized if the displayed elements or display contents are correctly superimposed or cumulated. In the event of a failure and/or an error in one of the visualization or display channels, the display is incomplete or atypical. The user can recognize such an error immediately.

The correct or expected display on the display device may also be achieved by optical superimposition of two primary colors. If a display content must be yellow, for example an operating symbol or a graphically visualized indicator light, this display content is expected by the user in this color. In this case, the display content on the first display may be red and the locally superimposed display content on at least one second display may be green—or vice versa. The information displayed by the display device as a whole, for example the operating symbol, then appears correctly and as intended in yellow. A plausible or adequate display on the display device allows the user to recognize that both or all display or control channels are error-free. The same applies to the alternatively or combinatorially realizable superimposition of graphic representations or shapes.

With the display device according to the invention, a visualization of safety-relevant information or system-relevant instructions can be made safer. Technical systems can thus be operated as fail-safe and reliable as possible.

Two or more displays may be superimposed on each other, which cumulatively visualize an information to be displayed, wherein the corresponding graphic and/or color representation can be perceived by the human eye and can be checked by the user regarding plausibility.

According to an expedient embodiment, the information or representation visualized cumulatively or as a whole by the first and the at least one second display is formed by at least one preferably graphic symbol, which symbol is provided for manual operation and/or monitoring of technical systems that can be manually controlled and influenced. Such a display device offers significant advantages, particularly in conjunction with control and/or display elements.

The at least one symbol may be formed by a symbol for a machine operation, in particular according to standard EN 60204-1 or IEC 60417.

According to an advantageous embodiment, the first display and the at least one second display are configured to generate a mixed color, in particular yellow, by subtractive or additive color mixing of a first color for the first display content, for example red, and a second color for the second display content, for example green. This yellow representation can then be recognized by an operator as plausible or planned. If, contrary to expectations, a different or atypical representation appears on the display device, this can be quickly recognized by the user as a system error or technical fault.

Alternatively or in combination with color superimposing, the first display and the at least one second display may be configured to display or output at least one portion of the information or representation to be visualized on the first display and the at least one completing portion of the information or representation to be visualized on the at least one second display. This also means that technical faults or irregularities in the control system can be quickly and clearly detected by a user.

It is useful if the first and the at least one second display are configured as graphics-enabled displays and each enable representations with a color depth of at least 8 bits, in particular at least 24 bits. The ability to visualize hundreds or several million colors means that an attractive appearance can be created that differs little or not at all from standard display devices.

According to an expedient advancement, a touch-sensitive, transparent, or at least partially translucent input means for manual input of control or operating commands may be arranged upstream of the at least one second display in the normal direction to its second display surface. This touch-sensitive input means may be configured as a film. This makes it possible to create an advantageous touch-sensitive input and output device, in particular a touch panel.

The at least one second display may be configured as an OLED display. This enables deep black levels and therefore a high level of detail and good contrast can be achieved on the display device. In addition, a high level of transparency or translucency can be achieved with such a display.

Furthermore, the at least one second display may be configured as a projection-based display with a light projector. This also makes it possible to achieve high transparency or translucency for the first display underneath or behind it.

The first display may be configured as a LCD display with backlighting. This enables a high brightness of its display contents. A reduction in brightness of the display contents on the first display due to the at least one second, upstream display can thus be easily compensated for or neglected.

It is expedient if a generic or common display control device and/or a first and at least one second display control device is or are configured, which is or are configured to respectively proportionally display the color representations on the first and the at least one second display and/or which is or are configured to mutually supplement or complete the overall graphic representations to be displayed on the first and/or the at least one second display. This enables a controlled operation of the display device to the intended usage.

The object of the invention is also solved by a control system for controlling potentially dangerous technical systems, such as industrial plants, machines, or motor vehicles. This control system comprises at least one safety circuit with at least one safety switching element that can be manually actuated by an operator, for example an emergency stop or enabling actuating element, at least one control device for controlling sequences in the technical system, and a display device according to the invention, which is functionally coupled to the at least one control device. This creates an improved control system, which in particular offers increased display reliability.

In particular, the use of the display device according to the invention as a fail-safe display means in control systems of potentially dangerous technical systems, such as industrial plants, machines or motor vehicles, is of particular advantage.

The object of the invention is also solved by a method for displaying information on an electronically controllable display device. The information to be displayed on the display device can be visually perceived by the human eye of a user. The display device comprises a first and at least one second display. The first display has a first display surface, which is provided or configured to visualize the first display contents. The at least one second display has a second display surface, which is provided or configured to visualize second display contents. The first and second display surfaces of the first display and of the at least one second display are arranged one after the other or one behind the other in the normal direction to the first and second display surfaces. In addition, the first and second display surfaces are arranged to at least partially overlap one another, in particular they are positioned to positioned to cover or superimpose one another. The at least one second display is transparent or partially translucent in the normal direction to its second display surface, so that display contents on the first display surface of the first display can be perceived by the human eye through the second display surface in the normal direction to the second display surface. The method according to the invention comprises the following steps:
computer-based division of the information or representation to be displayed into first display contents and second display contents,
displaying the first display contents on the first display and displaying the second display contents on the at least one second display,
optically or visually superimposing color representations of the first and second display contents and/or optically or visually supplementing or combining the first and second display contents, so that the information provided for a display is completed,
wherein the representation or information displayed by the first and the at least one second display is completed or cumulatively displayed in such a way that it can be evaluated by a user of the display device with regard to plausibility or can be recognized or checked with regard to its correctness.

This method makes it possible to operate technical systems with increased security against malfunction or failure.

The information cumulated or visualized as a whole by the first and the at least one second display may be formed by at least one preferably graphic symbol, which symbol can be used for operating and/or monitoring technical systems that can be controlled and influenced manually.

In this display or visualization method, it may also be provided that the first display and the at least one second display are used in such a way that by subtractive or additive color mixing of a first color for the first display content, for example red, and a second color for the second display content, for example green, a mixed color, thus yellow, is generated which can be perceived by an operator as plausible or planned.

Alternatively or in combination with superimposing colors, it may be provided that the first display and the at least one second display are used in such a way that at least a portion of the information or representation to be visualized is displayed or output on the first display and at least a completing portion of the information or representation to be visualized is displayed or output on the at least one second display.

According to an advancing method measure, it may be provided that a touch-sensitive, transparent or partially translucent input means is arranged upstream of the at least one second display in the direction normal to its second display surface, via which input means control or operating commands can be manually entered by a user and these are used to operate and/or monitor potentially dangerous technical systems, such as industrial systems, machines or motor vehicles. A touch panel of this type enables safe monitoring and control of technical systems with the involvement of an operator.

For a better understanding of the invention, it is explained in more detail with the aid of the following figures.

The figures show a simplified, exemplary representation as follows:

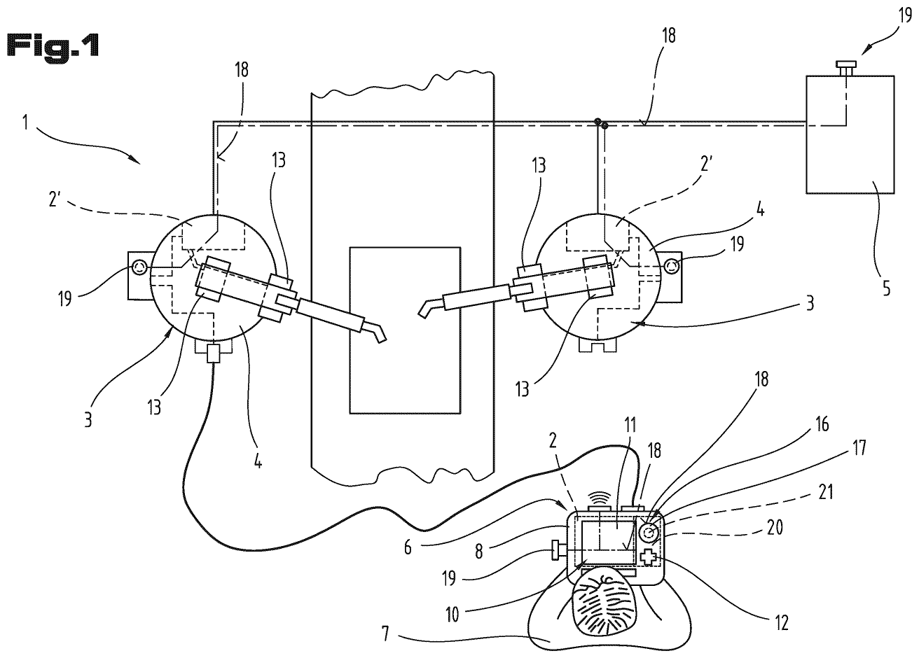

FIG. 1 an electronic control system for an industrial plant;

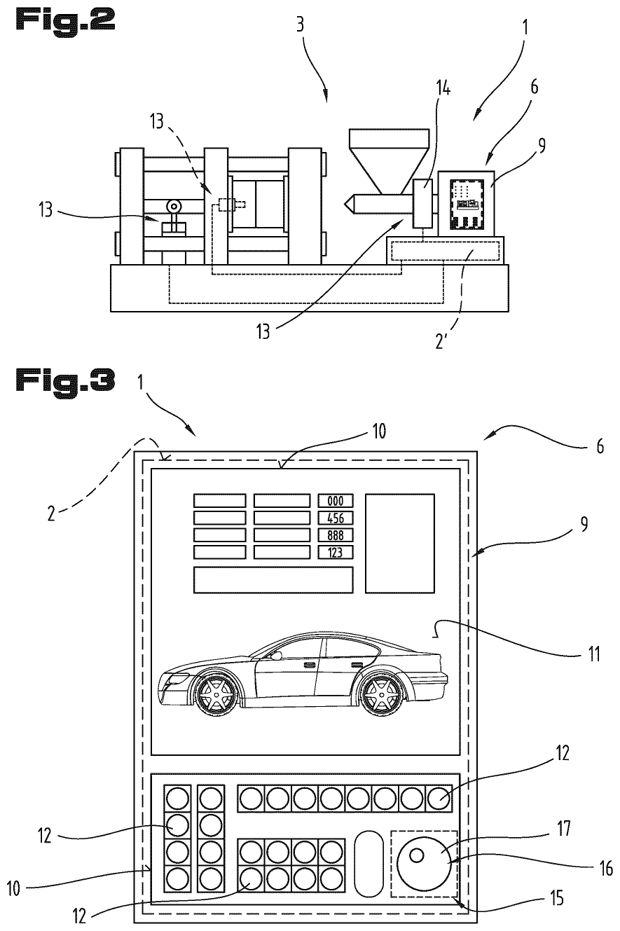

FIG. 2 an electronic control system for a machine;

FIG. 3 an electronic control system for a motor vehicle;

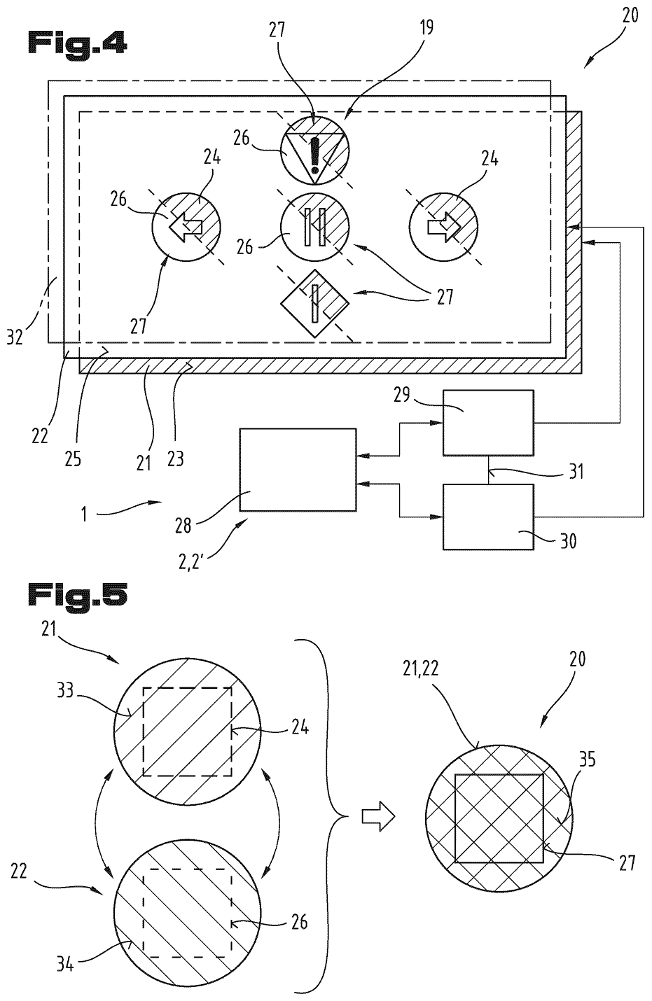

FIG. 4 a display device with a first and at least one second display;

FIG. 5 an example of color and/or shape superimposition by a first and at least a second display;

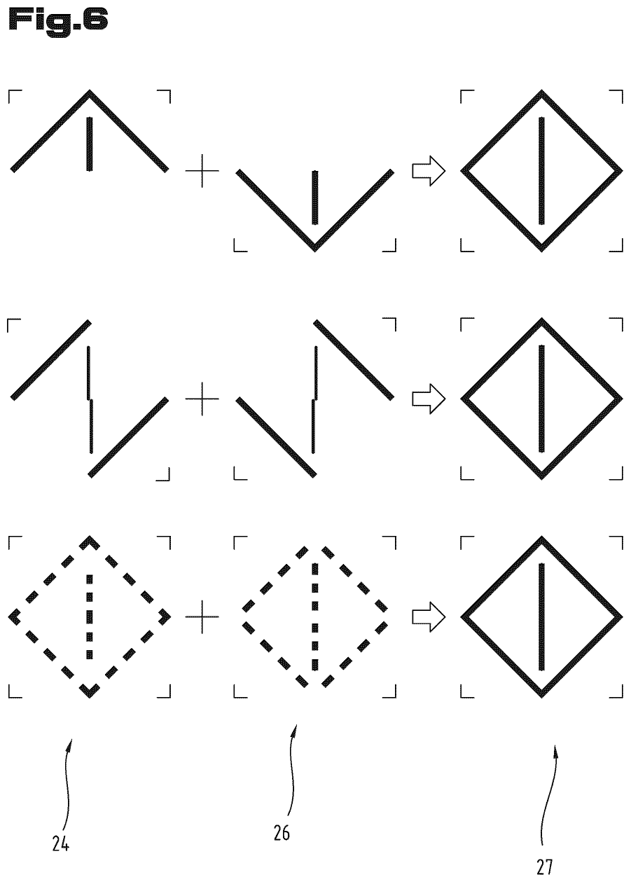

FIG. 6 Examples of display content superimposition for displaying a graphical symbol on a display device comprising a first display and at least one second display.

By way of introduction, it should be noted that in the various embodiments described, the same parts are provided with the same reference signs or the same component designations, wherein the disclosures included in the entire description may be transferred analogously to the same parts with the same reference signs or the same component designations. The position details chosen in the description, such as top, bottom, side, etc., also refer to the directly described and illustrated figure and these position details are to be transferred to the new position accordingly in the event of a change of position.

FIGS. 1 to 3 show exemplary embodiments of electrotechnical or electronic control systems 1 for controlling potentially dangerous technical plants or systems, such as industrial plants, machines or motor vehicles.

The control systems 1 shown as examples in FIGS. 1 and 2 are specifically intended for the automation or control of industrial plants or machines. Such an industrial plant or its control system 1 comprises at least one electronic control device 2; it may also be provided a plurality of distributed electronic control devices 2, 2′. A corresponding plant comprises at least one machine 3 or a plurality of possibly interacting machines 3 or machine components. The at least one electronic control device 2, 2′ has preferably a software-controlled configuration and serves primarily to implement the respective control functions of the respective industrial machine 3 or to be able to monitor, influence and/or program the processes of the machine 3. The same applies to the at least one electronic control device 2, 2′ of an autonomously or semi-autonomously operable motor vehicle.

According to the exemplary embodiment shown in FIG. 1, such an industrial machine 3 can be formed by at least one industrial robot 4. Such an industrial robot 4 may be part of an assembly or production plant. By linking the respective control devices 2, 2′ using data technology, it may be provided that the industrial robots 4 can interact in terms of control technology. Such data and control linkage between several industrial robots 4 may also include a central master computer 5. With regard to a centralized, decentralized, hierarchical or otherwise structured control architecture and linkage, a wide variety of designs are conceivable, which may be selected by the specialist according to the respective requirements.

At least one human-machine interface (HMI) 6 may be assigned or assignable to at least one control device 2′ of at least one machine 3. This human-machine interface 6 enables control-related interactions between an operator 7 and the respective machine 3.

In the exemplary embodiment shown in FIG. 1, the human-machine interface 6 implemented by control technology is formed by a mobile or portable hand-held operating device 8. In the embodiment shown in FIG. 2, the human-machine interface 6 is defined by a stationary control panel 9. In the case of a motor vehicle, the human-machine interface is a component of the motor vehicle cockpit. The respective human-machine interfaces 6 may therefore also be referred to as operator interfaces.

A conventional hand-held operating device 8 or operating panel 9 may have at least one control input and output device 10, such as a touch screen 11, input keys 12, switches or other electrical or electromechanical input and output means. In addition, visually and/or acoustically detectable output means may be provided. In a generic hand-held operating device 8 or operating panel 9, the aforementioned touch screen 11 and light elements or signaling lamps for displaying system-relevant data or states may be provided in particular. The range of functions and the embodiment of the respective input device or the respective output device depend heavily on the respective application, in particular on the technical complexity of the machine 3 or system to be controlled. It is essential that the operator 7 can control or monitor, influence and/or program the required control processes by means of the control input and output device 10, for example by means of the aforementioned touch screen 11.

The control device 2 implemented in the man-machine interface 6, in particular in the hand-held control unit 8 or in the control panel 9, and the control device 2′ functionally assigned to a machine 3 may interact via wired and/or wireless communication interfaces in terms of data or control technology.

As is known per se, controllable, in particular at least activable and deactivable motion drives 13 are provided for the automation of the respective machines 3, which are line-connected to the respective control device 2′. The drive speed and/or drive power or drive force of such motion drives 13 may often also be adjustable or changeable as required. As illustrated in FIG. 1 and FIG. 2, such motion drives 13 may be formed by motors 14, by hydraulic cylinders, by proportional solenoid valves or by other elements for the active or controllable movement of machine components. The corresponding motion drives 13 are also actuators that can be used to generate or initiate an adjustment movement of a machine component. Such a motion drive 13 and the respective machine component may also be referred to as a machine axis. A controllable machine component or machine axis may be understood to mean, for example, an articulated arm of an industrial robot 4, a feed unit, a processing unit of a machine tool, an actuator of a production machine, a steering and/or motion drive of a motor vehicle and the like. Typically, a plurality of sensors, limit switches and/or encoders may also be connected to such a control device 2′, as is generally known. This allows movement or functional sequences of the respective machine or motor vehicle to be executed fully automatically or at least semi-automatically or to be monitored automatically.

For manual control or programming of the respective motion drives 13 or machine components, at least one control element 15 may be provided on the respective human-machine interface 6 for manual influencing or specifying of adjustment movements of at least one of the system components or machine axes. This manual influencing or specifying of adjustment movements by an operator 7 preferably includes the option of changing the speed and/or power of the travel or motion drive 13 to be controlled or selectively controlled. In addition, operating elements, in particular push-button or switching elements, may be provided which are configured to activate or deactivate a selected or controllable movement drive 13. Instead of or in combination with motion drives 13, other actuators may also be provided within the technical system to be controlled, such as heating or cooling devices, optical devices, ventilation devices or the like.

At least one of the control elements 15 on the human-machine interface 6 may be configured as a rotary actuator control element 16 with an actuating element 17 that can be rotated endlessly or without a stop. Endless rotatability means that the rotary actuator operating element 16 or its actuating element 17 is configured in such a way that there are no mechanical end stops or no permanent limitation with regard to the rotational movement of the actuating element 17. This is in contrast to a typical potentiometer or adjustable ohmic resistor, which usually has a rotation or adjustment range of around 270°. A rotary actuator control element 16 is more comparable to a so-called override potentiometer or the rotary actuator control element 16 may be configured as an endlessly rotatable incremental encoder. It is advantageous if the rotary actuator control element 16 enables endless rotation of its, for example, disk- or wheel-shaped actuating element 17 and the associated unlimited output of sensor pulses or increments.

As explained above, an electronic control system 1, which comprises at least one control device 2, 2′, may be used for a variety of applications or systems. In particular, it may be used for industrial or process automation, for the operation of machines or for the operation of manually, semi-autonomously or autonomously controlled motor vehicles or self-propelled machines.

If the control system 1 is used to monitor or control potentially dangerous technical systems, such as industrial plants, machines or motor vehicles, it is useful if the control system 1 comprises at least one safety circuit 18 for reliably establishing or initiating a safe state, in particular an emergency stop state and/or a safe braking state or another safe operating state. At least one safety switching element 19, for example an emergency stop and/or enabling actuating element, which can be manually actuated by an operator 7, is functionally integrated into the at least one safety circuit 18. Manual actuation of one of the safety switching elements 19 within the at least one safety switching circuit 18 places the potentially dangerous technical system or a potentially critical portion of the technical system in a safe state with high functional reliability. As is well known, this is intended to avert danger and damage or injury to people and/or machines or to keep them at a distance.

In the exemplary embodiment according to FIG. 1, the at least one safety circuit 18 of the technical plant is wired. The safety switching element 19 on the hand-held control unit 8 may be integrated into a wireless and/or wired safety circuit 18.

FIG. 4 shows a control system 1 with at least one display device 20, which is configured to electronically control the visualization of control-relevant or monitoring-relevant information. The representations and information or data that can be visualized on this display device 20 can be visually detected or perceived by the human eye of an operator 7 and can be evaluated by this user with regard to their plausibility. In particular, at least some of the information visualized by the display device 20 can be evaluated by the user with regard to its completion or its expected appearance.

For this purpose, the display device 20 according to the invention comprises a first display 21 and at least one second display 22. The first display 21 has a first display surface 23, which is configured or provided for visualizing first display contents 24. Examples of first display contents 24 of the first display 21 have been marked in FIG. 4 purely by way of example with a hatching for better differentiation or for easier comprehensibility. However, such hatching would typically not be part of the first display contents 24 of the first display 21.

The at least one second display 22 has a second display surface 25, which is configured or provided for visualizing second display contents 26. The first display surface 23 of the first display 21 and the second display surface 25 of the at least one second display 22 are arranged one after the other or one above the other in the normal direction to the first and second display surfaces 23, 25. In addition, the first display surface 23 and the second display surface 25 are arranged at least partially or completely overlapping one another. Accordingly, the first and second display areas 23, 25 are arranged partially or completely overlapping or overlapping each other.

The at least one second display 22 is transparent or at least partially translucent in the normal direction to its second display surface 25, so that first display contents 24 on the first display surface 23 of the first display 21 can be perceived by the human eye through the second display surface 25 in the normal direction to the second display surface 25. According to the exemplary representation in FIG. 4, the first display contents 24 are also recognizable by the operator 7 from the superimposed second display surface 25 due to the transparent or translucent second display surface 25.

The first display contents 24 are highlighted or indicated by hatching in FIG. 4. In the example shown in FIG. 4, these first display contents 24 are each formed by portions of symbols 27 for machine operation. In particular, half of the graphic operating symbols are provided for display on the first display 21 or on the first display surface 23. The remaining portions of the respective operating symbols, in particular their second halves, are provided for visualization or output on the at least one second display 22, which is/are functionally or graphically superimposed on the first display 21.

Two or more second displays 22 with a transparent or translucent display surface 25 may be arranged in series above the first display 21. The information or representation to be visualized on the display device 20, for example a graphic symbol 27 for machine operation, may be divided between the number of respective first and second displays 21, 22.

At least some of the second display contents 26 of the at least one second display 22 are provided to complete the translucent or underlying first display contents 24 of the first display 21. Accordingly, first display contents 24 of the first display 21 and second display contents 26 of the at least one second display 22 may be provided to complete or visualize information to be output on the display device 20 by superimposing color representations and/or by mutually supplementing or completing graphical representations. This correspondingly completed or completed information, for example an expected or typical operating symbol, can then be evaluated by a user of the display device 20 with regard to its plausibility or recognized or checked with regard to its correctness. In particular, atypical, incomplete or unexpected color representations on this display device 20 can be recognized by the operator as implausible or as clearly error related. This can increase the reliability of the display device 20 or the control system 1 equipped with it.

According to an expedient embodiment, the information provided for output on the display device 20 is formed by graphic symbols 27 for machine operation. For example, this information may be formed by a start symbol, a stop symbol, a symbol for a reset command, a symbol for a forward command, a symbol for a reverse command, or by a symbol 27 for the initiation of an emergency stop, as shown as an example in FIG. 4 in the upper section. In particular, at least one of the symbols 27, which is provided on the display device 20 for visualization, may be defined by a safety switching element 19, in particular by an enabling and/or emergency stop switching element. Symbols 27 for machine operation are defined in standards such as EN 60204-1 or IEC 60417.

The at least one second display 22, which is transparent or translucent in order to make the first display contents 24 recognizable from the first display 21 positioned behind or below it, may be configured as a projection-based display, as a LCD display, or as an OLED display or as a light-emitting diode film. In a projection-based display 22, the display contents 26 are projected onto or into a transparent pane or film by means of a light projector. The light projector may be arranged to the side of the transparent pane or film and, if necessary, display the corresponding projection via one or more mirrors. This pane or film may be made of plastic, for example PMMA, or glass. Projection-based, translucent displays 22 are also known as “head-up displays”, such as those used in motor vehicles. Translucent or transparent displays based on OLED, LCD or TFT are also available on the market.

The information or representation to be displayed by means of the first display 21 and the at least one superimposed second display 22 of the display device 20 may be implemented or controlled by means of a common display control device 28 and/or by means of a first display control device 29 and at least one second display control device 30.

According to the exemplary embodiment in FIG. 4, a common display control device 28 is provided, which may also be configured as a component of a functional or process-relevant control device 2, 2′ of the electronic control system 1. This control device 2, 2′ transfers the content to be displayed to the first display control device 29 and to the at least one second display control device 30. The first display control device 29 is functionally coupled, in particular line-connected, to the first display 21, and the at least one second display control device 30 is functionally coupled, in particular line-connected, to the at least one second display 22. The respective display control devices 28, 29, 30 are at least configured to determine the first display contents 24 and the second display contents 26, in particular to align and separate them. For this purpose, at least one data alignment line 31 may be provided between the display control devices 29, 30. The respective display control devices 28 and/or 29, 30 are to be understood as control devices and decisively determine the first and second display contents 24, 26 on the first display 21 and on the at least one second display 22. Accordingly, the display control devices 28 and/or 29, 30 are configured to divide or split the whole information to be visualized according to the display. In particular, the display control devices 28 and/or 29, 30 may be configured to display color representations on the first and the at least one second display 21, 22 proportionately in each case and/or to mutually supplement or complete the overall graphic representations to be displayed on the first display 21 and/or the at least one second display 22.

As may also be seen from the diagram according to FIG. 4, a touch-sensitive, transparent or at least partially translucent input means 32 for the manual input of control or operating commands may be arranged upstream of the at least one second display 22 in the normal direction to its second display surface 25. This input means 32 may be configured as a touch-sensitive film, indicated by a stroke-dotted line in FIG. 4, wherein touch points on its surface can be evaluated electronically. The display device 20 may therefore be configured as a touch panel.

As schematically illustrated in FIG. 5, the first display 21 and the at least one second display 22, which is structurally superimposed on the first display 21, may be configured or provided to generate a mixed color 35, for example yellow, and/or to generate a completed graphic symbol 27 by subtractive or additive color mixing of a first color 33 for the first display content 24 or as the first display content 24, for example red, and a second color 34 for the second display content 26 or as the second display content 26, for example green.

Alternatively or in combination with the superimposition or mixing of colors explained above, the first display 21 and the at least one second display 22 may be configured or provided to display or output at least one portion of the information or representation to be visualized on the first display 21 and the at least one completing portion of the information or representation to be visualized on the at least one second display 22, as shown in FIG. 5 and also in FIG. 6 by means of examples.

By means of the output of an expected mixed color 35 on the display device 20, for example yellow, and/or by means of a typically displayed symbol 27, for example a closed rectangle or square or a solid line, this information or representation can be perceived by an operator as plausible or recognized as planned. FIG. 5 shows such a planned or correct display status. If, on the other hand, the expected coloring and/or shape on the display device 20 were to be absent or appear atypical, or if the expected information or representation, in particular the respective symbol 27, were to appear incomplete, the operator can relatively clearly conclude that the display device 20 or the control system 1 is malfunctioning. This means that a potential malfunction in control system 1 or a malfunction of the system can be detected quickly and relatively clearly. Safeguarding, restart or shutdown measures can then be taken immediately in the faulty technical system.

FIG. 6 shows an incomplete list of examples for the safe display of a control-relevant symbol 27, in particular a start symbol for machines or for technical processes. In particular, the approach of graphic and form superimposition is explained using examples. Three examples of first display contents 24 are shown in the left-hand column and the second display contents 26 completing such display contents 24 are shown in the middle column. Accumulated or superimposed, the first and second display contents 24, 26 each result in a correctly or completely displayed symbol 27 for machine operation, in particular a plausible and clearly recognizable start symbol according to the rightmost column.

Depending on which operating symbol 27 is to be displayed, other graphical splits may be more suitable. A graphic symbol 27 or information or representation to be displayed is also to be understood as numbers, letters or graphic user interfaces of the display device 20.

An alternating representation of the display contents 24, 26, in particular those of the respective symbol sections, can also be used to detect a “freezing” of a display 21 or 22 or to clearly recognize a malfunction of the display device 20 or the control system 1.

The exemplary embodiments show possible embodiment variants, wherein it should be noted at this point that the invention is not limited to the specifically illustrated embodiment variants thereof, but rather various combinations of the individual embodiment variants with one another are also possible and this variation possibility lies within the ability of the skilled person working in this technical field due to the teaching on technical action by the present invention.

The scope of protection is determined by the claims. However, the description and the drawings should be consulted to interpret the claims. Individual features or combinations of features from the various exemplary embodiments shown and described may constitute inventive solutions in their own right. The object underlying the independent inventive solutions may be taken from the description.

Finally, as a matter of form, it should be noted that for ease of understanding of the structure, elements are partially not depicted to scale and/or are enlarged and/or are reduced in size.

List of reference signs

| | |
|---|---|
| 1 | control system |
| 2, 2′ | control device |
| 3 | machine |
| 4 | industrial robot |
| 5 | master computer |
| 6 | human machine interface |
| 7 | operator |
| 8 | hand-held control unit |
| 9 | control panel |
| 10 | input and output device |
| 11 | touch screen |
| 12 | input key |
| 13 | motion drive |
| 14 | motor |
| 15 | control element |
| 16 | rotary actuator control element |
| 17 | actuator |
| 18 | safety circuit |
| 19 | safety switching element |
| 20 | display device |
| 21 | first display |
| 22 | second display |
| 23 | first display surface |
| 24 | first display contents |
| 25 | second display surface |
| 26 | second display contents |
| 27 | graphic symbol |
| 28 | common display control device |
| 29 | first display control device |
| 30 | second display control device |
| 31 | alignment line |
| 32 | input means |
| 33 | first color |
| 34 | second color |
| 35 | mixed color |

1: A display device (20) for electronically controllable visualization of information, which information is visually perceptible by the human eye of a user, comprising
a first display (21) and at least one second display (22),
which first display (21) has a first display surface (23) which is configured to visualize first display contents (24), and
which at least one second display (22) has a second display surface (25) which is configured to visualize second display contents (26),
wherein the first display surface (23) of the first display (21) and the second display surface (25) of the at least one second display (22) are arranged one after the other in the normal direction to the first and second display surfaces (23, 25),
wherein the first display surface (23) and the second display surface (25) are arranged at least partially overlapping each other,
wherein the at least one second display (22) is transparent or at least partially translucent in the normal direction to its second display surface (25), so that first display contents (24) on the first display surface (23) of the first display (21) can be perceived by the human eye through the second display surface (25) in the normal direction to the second display surface (25),
and wherein first display contents (24) of the first display (21) and second display contents (26) of the at least one second display (22) are provided for visualization of information to be displayed by superimposing color representations and/or by mutually supplementing or completing graphic representations, and which representation can be evaluated by a user of the display device with regard to plausibility or can be checked with regard to its correctness.

2: The display device according to claim 1, wherein the representation or information visualized cumulatively by the first and the at least one second display (21, 22) is formed by at least one symbol (27), which symbol (27) is provided for manual operation and/or monitoring of technical systems which can be controlled and influenced manually.

3: The display device according to claim 2, wherein the at least one symbol (27) is formed by a symbol for a machine operation, in particular according to standard EN 60204-1 or IEC 60417.

4: The display device according to claim 1, wherein the first display (21) and the at least one second display (22) are configured to generate, by subtractive or additive color mixing of a first color (33) as first display content (24) or for the first display content (24), and a second color (34) as second display content (26) or for the second display content (26), a mixed color (35) which can be perceived by a user as plausible or planned.

5: The display device according to claim 1, wherein the first display (21) and the at least one second display (22) are configured to display at least a portion of the representation or information to be visualized on the first display (21) and the at least one completing portion of the representation or information to be visualized on the at least one second display (22).

6: The display device according to claim 1, wherein a touch-sensitive, transparent or at least partially translucent input means (32) for the manual input of control or operating commands is arranged upstream of the at least one second display (22) in the normal direction to its second display surface (25).

7: The display device according to claim 1, wherein the at least one second display (22) is configured as an OLED display.

8: The display device according to claim 1, wherein the first display (21) is configured as an LCD display with backlighting.

9: The display device according to claim 1, wherein a common display control device (28) and/or a first and at least one second display control device (29, 30) is/are configured, which is/are configured to respectively proportionally display the color representations on the first and the at least one second display (21, 22) and/or to mutually supplement or complete the overall graphic representations to be displayed on the first and the at least one second display (21, 22).

10: A control system (1) for controlling potentially dangerous technical systems, such as industrial plants, machines or motor vehicles, comprising
at least one safety circuit (18) with at least one safety switching element (19) which can be manually actuated by a user, for example an emergency stop or enabling actuating element,
at least one control device (2, 2′) for controlling processes in the technical system, and
a display device (20) according to claim 1, which is functionally coupled to the at least one control device (2, 2′).

11: A use of the display device (20) according to claim 1 as fail-safe display means in control systems (1) of potentially dangerous technical systems, such as industrial plants, machines or motor vehicles.

12: A method for displaying information on an electronically controllable display device (20), which is configured in particular according to claim 1, which information to be displayed is visually perceptible by the human eye of a user, the display device (20) comprising
a first display (20) and at least one second display (22),
which first display (21) has a first display surface (23) which is provided to visualize first display contents (24), and
which at least one second display (22) has a second display surface (25) which is provided to visualize second display contents (26),
wherein the first display surface (23) of the first display (21) and the second display surface (25) of the at least one second display (22) are arranged one after the other in the normal direction to the first and second display surfaces (23, 25),
wherein the first display surface (23) and the second display surface (25) are arranged at least partially overlapping each other,
wherein the at least one second display (22) is transparent or at least partially translucent in the normal direction to its second display surface (25), so that first display contents (24) on the first display surface (23) of the first display (21) can be perceived by the human eye through the second display surface (25) in the normal direction to the second display surface (25),
the method comprising the following steps:
dividing the information to be displayed into first display contents (24) and second display contents (26),
displaying the first display contents (24) on the first display (21) and displaying the second display contents (26) on the at least one second display (22),
wherein the information or representation to be displayed is completed by optically superimposing color representations of the first and second display contents (24, 26) and/or by mutually supplementing or combining the first and second display contents (24, 26),
and wherein the information or representation displayed completed or cumulated by the first display (21) and by the at least one second display (22) can be evaluated by a user of the display device (20) with regard to plausibility or can be checked with regard to its correctness.

13: The method according to claim 12, wherein the information cumulatively visualized by the first display (21) and the at least one second display (22) is formed by at least one symbol (27), which symbol (27) is used for manual operation and/or monitoring of technical systems which can be manually controlled and influenced.

14: The method according to claim 12, wherein the first display (21) and the at least one second display (22) are used in such a way that a mixed color (35) is generated by subtractive or additive color mixing of a first color (33) as first display content (24) or for the first display content (24), and a second color (34) as second display content (26) or for the second display content (26), which mixed color can be perceived by a user as plausible or planned.

15: The method according to claim 12, wherein the first display (21) and the at least one second display (22) are used such that at least a portion of the information or representation to be visualized is displayed on the first display (21) and at least a completing portion of the information or representation to be visualized is displayed on the at least one second display (22).

16: The method according to claim 12, wherein a touch-sensitive, transparent or partially translucent input means (32) is arranged upstream of the at least one second display (22) in the direction normal to the second display surface (25), via which input means (32) control or operating commands desired by a user can be entered manually and are used for operating and/or monitoring potentially dangerous technical systems, such as industrial plants, machines or motor vehicles.
